(19) United States
(12) Patent Application Publication
(10) Pub. No.: US 2025/0292713 A1
(43) Pub. Date: Sep. 18, 2025

(54) OPTICAL COMPENSATION DEVICE, DISPLAY DEVICE, METHOD OF OPTICALLY COMPENSATING DISPLAY DEVICE, AND ELECTRONIC APPARATUS INCLUDING DISPLAY DEVICE

(71) Applicant: Samsung Display Co., LTD., Yongin-si (KR)

(72) Inventor: SI-BEAK PYO, Yongin-si (KR)

(21) Appl. No.: 19/024,307

(22) Filed: Jan. 16, 2025

(30) Foreign Application Priority Data
Mar. 14, 2024 (KR) 10-2024-0035722

(51) Int. Cl. G09G 3/20; G01J 1/42; G01J 1/44; G01J 3/50

(52) U.S. Cl. CPC G09G 3/2003; G01J 1/44; G01J 3/506; G01J 2001/4247; G09G 2320/0233; G09G 2320/0242; G09G 2360/16

(57) ABSTRACT

An optical compensation device includes a first optical measurer which measures first optical information of a first area of a display device and second optical information of a second area of the display device next to the first area, a target calculator which calculates first target optical information by compensating the second optical information based on an offset lookup table including an offset related to a difference between the first area and the second area, and a gamma determiner which determines a first reference gamma voltage for the first area such that a difference between the first optical information and the first target optical information is within a reference range.

This application claims priority to Korean Patent Application No. 10-2024-0035722, filed on Mar. 14, 2024, and all the benefits accruing therefrom under 35 U.S.C. § 119, the content of which in its entirety is herein incorporated by reference.

### BACKGROUND

### 1. Field

Embodiments relate to an optical compensation device. More particularly, embodiments relate to an optical compensation device for a display device, a display device optically compensated by an optical compensation device, a method of optically compensating a display device, and an electronic apparatus including a display device.

### 2. Description of the Related Art

A deviation may occur between a luminance or a color coordinate of an image that a display device intends to display and a luminance or a color coordinate of an image actually displayed by the display device, respectively. Accordingly, a multi-time programming (“MTP”) to repeatedly compensate/correct optical characteristics (or gamma characteristics) of the display device, may be performed during or after a manufacturing process of the display device.

Further, a luminance deviation or a color coordinate deviation may occur between areas of the display device. When the display device includes a transparent area that transmits external light and a non-transparent area that does not transmit external light, a luminance deviation or a color coordinate deviation may occur between the transparent area and the non-transparent area, and an MTP for the transparent area to repeatedly compensate/correct optical characteristics (or gamma characteristics) of the transparent area may be performed.

### SUMMARY

Embodiments provide an optical compensation device that improves a display quality of a display device.

Embodiments provide a display device with an improved display quality and an electronic apparatus including the display device.

Embodiments provide a method of optically compensating a display device for improving a display quality of the display device.

An optical compensation device in an embodiment includes a first optical measurer which measures first optical information of a first area of a display device and second optical information of a second area of the display device next to the first area, a target calculator which calculates first target optical information by compensating the second optical information based on an offset lookup table including an offset related to a difference between the first area and the second area, and a gamma determiner which determines a first reference gamma voltage for the first area so that a difference between the first optical information and the first target optical information is within a reference range.

In an embodiment, the first optical information may include at least one of a luminance and a color coordinate of the first area, and the second optical information may include at least one of a luminance and a color coordinate of the second area.

In an embodiment, the first area may display an image and transmits external light, and the second area may display the image and may not transmit the external light.

In an embodiment, the first optical measurer may include a first probe which measures the first optical information and a second probe which measures the second optical information, and a length of a first light path from the first probe to the first area may be different from a length of a second light path from the second probe to the second area.

In an embodiment, the first optical measurer may further include a camera module for automatically aligning the first probe to the first area.

In an embodiment, the offset may be set for each of reference grayscales included in each of display brightness values of the display device.

In an embodiment, the offset lookup table may include a luminance offset lookup table including a luminance offset related to a luminance difference between the first area and the second area, and a color coordinate offset lookup table including a color coordinate offset related to a color coordinate difference between the first area and the second area.

In an embodiment, the luminance offset may represent a luminance deviation rate of the first area to the second area, and the color coordinate offset may represent a color coordinate deviation amount of the first area to the second area.

In an embodiment, the target calculator may calculate the first target optical information by increasing or decreasing the second optical information by the offset.

In an embodiment, the optical compensation device may further include a second optical measurer which measures third optical information of a third area of the display device. The gamma determiner may determine a second reference gamma voltage for the third area so that a difference between the third optical information and second target optical information is within the reference range.

In an embodiment, the third area may and the first area may constitute a display area of the display device and may not overlap each other.

A display device in an embodiment includes a display panel including a first area and a second area next to the first area, a gamma voltage generator which generates a first gamma voltage based on a first reference gamma voltage for the first area determined so that a difference between first optical information of the first area and first target optical information is within a reference range, and a data driver which converts image data for the first area into a data voltage for the first area based on the first gamma voltage and provides the data voltage for the first area to the first area. The first target optical information is calculated by compensating second optical information of the second area based on an offset lookup table including an offset related to a difference between the first area and the second area.

In an embodiment, the first optical information may include at least one of a luminance and a color coordinate of the first area, and the second optical information may include at least one of a luminance and a color coordinate of the second area.

In an embodiment, the first area may display an image and transmit external light, and the second area may display the image and may not transmit the external light.

In an embodiment, the display device may further include an optical module disposed under the display panel and overlapping the first area.

A method of optically compensating a display device in an embodiment may includes measuring first optical information of a first area of the display device and second optical information of a second area of the display device next to the first area, calculating first target optical information by compensating the second optical information based on an offset lookup table including an offset related to a difference between the first area and the second area, and determining a first reference gamma voltage for the first area so that a difference between the first optical information and the first target optical information is within a reference range.

In an embodiment, the first optical information may include at least one of a luminance and a color coordinate of the first area, and the second optical information may include at least one of a luminance and a color coordinate of the second area.

In an embodiment, the first area may display an image and transmit external light, and the second area may display the image and may not transmit the external light.

In an embodiment, the method may further include measuring third optical information of a third area of the display device, and determining a second reference gamma voltage for the first area so that a difference between the third optical information and second target optical information is within the reference range.

In an embodiment, the third area and the first area may constitute a display area of the display device and do not overlap each other.

In an electronic apparatus including a display device which displays an image and a processor which provides image data to the display device in an embodiment, the display device includes a display panel including a first area and a second area next to the first area, a gamma voltage generator which generates a first gamma voltage based on a first reference gamma voltage for the first area determined so that a difference between first optical information of the first area and first target optical information is within a reference range, and a data driver which converts image data for the first area into a data voltage for the first area based on the first gamma voltage and provides the data voltage for the first area to the first area. The first target optical information is calculated by compensating second optical information of the second area based on an offset lookup table including an offset related to a difference between the first area and the second area.

In the optical compensation device, the display device, the method of optically compensating the display device, and the electronic apparatus in the embodiments, the first target optical information may be calculated by compensating the second optical information based on the offset lookup table including the offset related to the difference between the first area and the second area, and the first reference gamma voltage for the first area may be determined such that the difference between the first optical information and the first target optical information is within the reference range, so that a multi-time programming (“MTP”) for the first area may be accurately performed. Accordingly, a contrast between the third (normal) area and the first area may decrease, and the display quality of the display device may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram showing an embodiment of an optical compensation device.

FIG. 2 is a plan view showing a display device of FIG. 1.

FIG. 3 is a cross-sectional view taken along line I-I′ of FIG. 2.

FIG. 4 is a view for describing capturing an image of a display device using the optical compensation device of FIG. 1.

FIG. 5 is a view showing a luminance offset lookup table.

FIG. 6 is a view showing a color coordinate offset lookup table.

FIG. 7 is a graph showing a luminance deviation rate of a first area to a second area.

FIG. 8 is a table for describing a calculation of a first target luminance.

FIG. 9 is a block diagram showing a display device of FIG. 1.

FIG. 10 is a flowchart showing an embodiment of a method of optically compensating a display device.

FIG. 11 is a flowchart showing performing a multi-time programming (“MTP”) for a normal area of FIG. 10.

FIG. 12 is a flowchart showing performing a MTP for a first area of FIG. 10.

FIG. 13 is a block diagram showing an embodiment of an electronic apparatus.

### DETAILED DESCRIPTION

Hereinafter, an optical compensation device, a display device, a method of optically compensating a display device, and an electronic apparatus in embodiments of the disclosure will be described in more detail with reference to the accompanying drawings. The same or similar reference numerals will be used for the same elements in the accompanying drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terms such as “measurer” or “calculator” or “determiner” as used herein are intended to mean a hardware component that performs a predetermined function. The hardware component may include a circuitry such as a field-programmable gate array (“FPGA”) or an application-specific integrated circuit (“ASIC”), for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

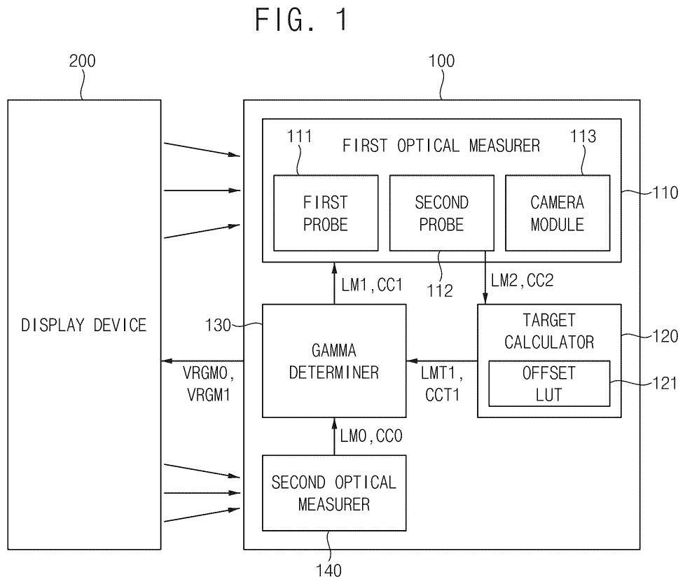

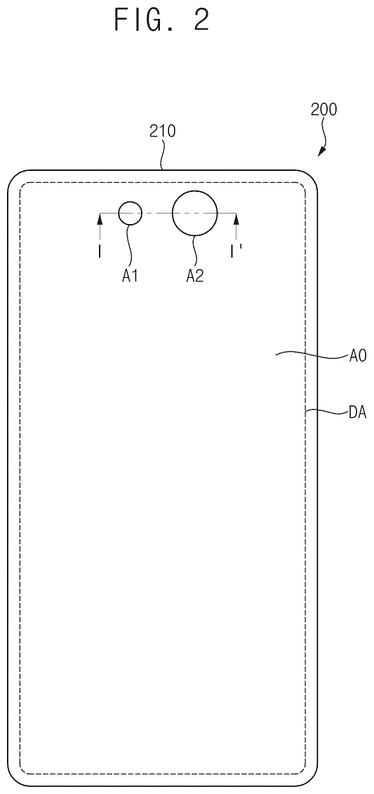

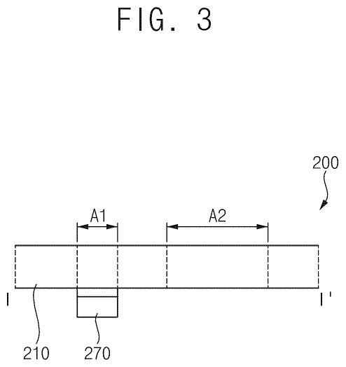

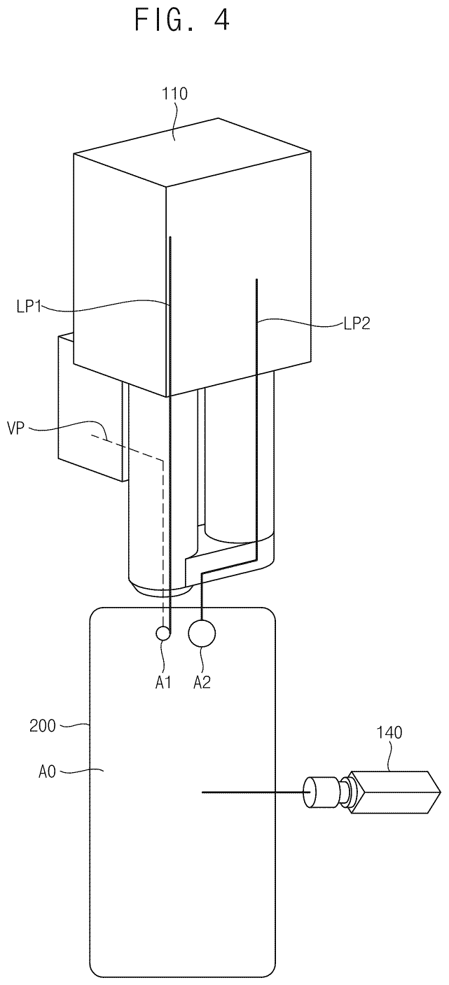

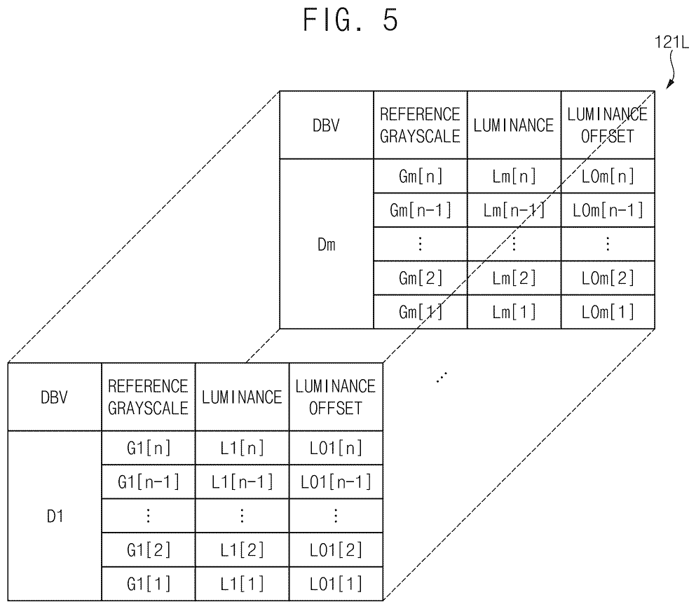

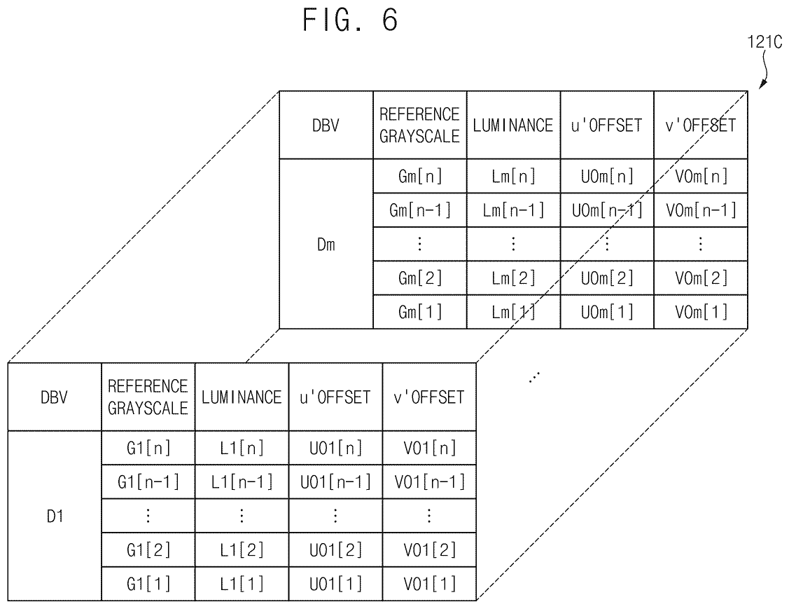

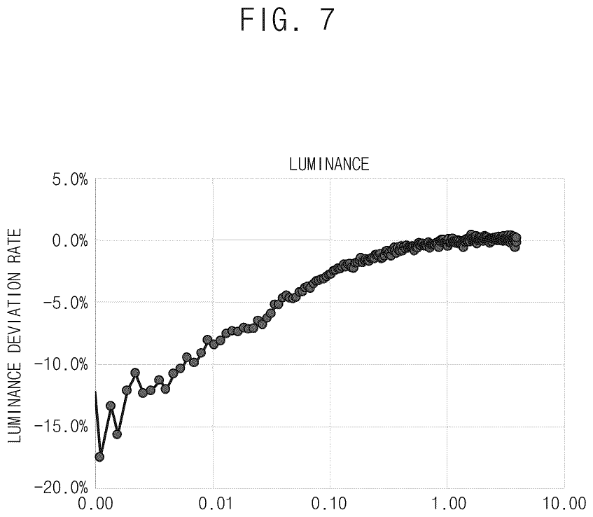

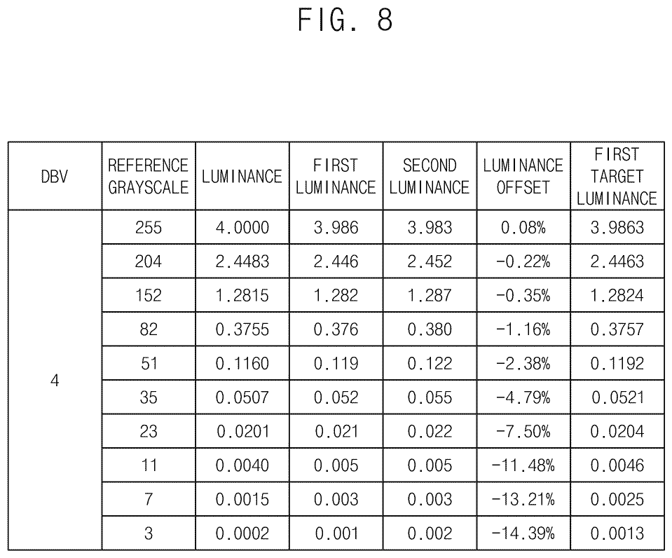

FIG. 1 is a block diagram showing an embodiment of an optical compensation device 100. FIG. 2 is a plan view showing a display device 200 of FIG. 1. FIG. 3 is a cross-sectional view taken along line I-I′ of FIG. 2. FIG. 4 is a view for describing capturing an image of the display device 200 using the optical compensation device 100 of FIG. 1. FIG. 5 is a view showing a luminance offset lookup table 121L. FIG. 6 is a view showing a color coordinate offset lookup table 121C. FIG. 7 is a graph showing a luminance deviation rate of a first area A1 to a second area A2. FIG. 8 is a table for describing a calculation of a first target luminance LMT1.

Referring to FIGS. 1 to 8, an optical compensation device 100 may measure normal optical information (also referred to as third optical information or main optical information) of a normal area (also referred to as a third area or a main area) A0 of a display device 200, first optical information of a first area A1, and second optical information of a second area A2, and may determine normal reference gamma voltages (also referred to as second reference gamma voltages or main reference gamma voltages) VRGM0 for the normal area A0 and first reference gamma voltages VRGM1 for the first area A1. The optical compensation device 100 may determine the normal reference gamma voltages VRGM0 for the normal area A0 by comparing the normal optical information of the normal area A0 with normal target optical information. The optical compensation device 100 may determine the first reference gamma voltages VRGM1 for the first area A1 by comparing the first optical information of the first area A1 with the second optical information of the second area A2.

The optical compensation device 100 may include a second optical measurer 140, a first optical measurer 110, a target calculator 120, and a gamma determiner 130.

The second optical measurer 140 may measure the normal optical information of the normal area A0 of the display device 200. The normal area A0 may be an area excluding the first area A1 among a display area DA of the display device 200. The normal area A0 may include the second area A2. The normal area A0 may be an area that displays an image and does not transmit external light.

In an embodiment, the normal optical information may include at least one of a luminance and a color coordinate of the normal area A0. Hereinafter, it will be described that the normal optical information includes a normal luminance LM0 and a normal color coordinate CC0 of the normal area A0.

In an embodiment, the second optical measurer 140 may measure the normal luminance LM0 and the normal color coordinate CC0 by capturing an image of a central area of the display device 200.

The first optical measurer 110 may measure the first optical information of the first area A1 of the display device 200 and the second optical information of the second area A2 of the display device 200 adjacent (or next) to the first area A1. The first area A1 may be an area that displays an image and transmits external light. In an embodiment, the first area A1 may be referred to as an under panel camera (“UPC”) area or an under panel sensor (“UPS”) area, for example. The second area A2 may be an area that displays an image and does not transmit external light.

Since the normal area A0 is an area that does not transmit external light and the first area A1 is an area that transmits external light, although the normal area A0 and the first area A1 display an image having the same grayscale, a luminance of the normal area A0 and a luminance of the first area A1 may be different, and a color coordinate of the normal area A0 and a color coordinate of the first area A1 may be different. In this case, a contrast between the normal area A0 and the first area A1 may increase, and the first area A1 may be recognized. In order to reduce the contrast between the normal area A0 and the first area A1, the optical compensation device 100 may determine the first reference gamma voltages VRGM1 for the first area A1 by comparing the first optical information of the first area A1 with the second optical information of the second area A2.

In an embodiment, the first optical information may include at least one of a luminance and a color coordinate of the first area A1, and the second optical information may include at least one of a luminance and a color coordinate of the second area A2. Hereinafter, it will be described that the first optical information includes a first luminance LM1 and a first color coordinate CC1 of the first area A1, and the second optical information includes a second luminance LM2 and a second color coordinate CC2 of the second area A2.

In an embodiment, the first optical measurer 110 may include a first probe 111 that measures the first luminance LM1 and the first color coordinate CC1 of the first area A1, a second probe 112 that measures the second luminance LM2 and the second color coordinate CC2 of the second area A2, and a camera module 113 for automatically aligning the first probe 111 to the first area A1.

The first probe 111 may measure the first luminance LM1 and the first color coordinate CC1 by capturing an image of the first area A1. The first optical measurer 110 may be moved on the display device 200 such that the first probe 111 is automatically aligned to the first area A1 by the camera module 113. The second probe 112 may measure the second luminance LM2 and the second color coordinate CC2 by capturing an image of the second area A2.

The first probe 111 may capture an image of the first area A1 through a first light path LP1 which is a vertical light path. The second probe 112 may capture an image of the second area A2 through a second light path LP2 that extends in a horizontal direction to capture an image of the second area A2. In this case, a length of the first light path LP1 from the first probe 111 to the first area A1 may be different from a length of the second light path LP2 from the second probe 112 to the second area A2.

The camera module 113 may capture an image of the display device 200 through a vision path VP. In this case, the vision path VP may partially overlap the first light path LP1.

Even when the first area A1 is an area that does not transmit external light and the first area A1 and the second area A2 display an image having the same grayscale, a difference in the length between the first light path LP1 and the second light path LP2 and a partial overlap between the first light path LP1 and the vision path VP may cause a luminance deviation between the first luminance LM1 of the first area A1 and the second luminance LM2 of the second area A2 and a color coordinate deviation between the first color coordinate CC1 of the first area A1 and the second color coordinate CC2 of the second area A2. In an embodiment, as shown in FIG. 7, when the first area A1 and the second area A2 display an image having relatively low grayscale (or relatively low luminance), a relatively large luminance deviation may occur between the first luminance LM1 of the first area A1 and the second luminance LM2 of the second area A2, for example.

The target calculator 120 may calculate first target optical information (first target luminance LMT1 and first target color coordinate CCT1) by compensating the second optical information (the second luminance LM2 and the second color coordinate CC2) based on an offset lookup table 121 including an offset related to a difference between the first area A1 and the second area A2.

In an embodiment, the offset may be set for each of reference grayscales included in each of display brightness values DBV of the display device 200. The display brightness values DBV may be preset brightness levels of the display device 200. The reference grayscales may be predetermined grayscales among entire grayscales. In an embodiment, the reference grayscales may include grayscales of 3, 7, 11, 23, 35, 51, 87, 152, 204, and 255 among 256 total grayscales from 0 to 255, for example. The offset lookup table 121 may include offsets corresponding to the display brightness values DBV and the reference grayscales.

In an embodiment, the offset lookup table 121 may include a luminance offset lookup table 121L including a luminance offset related to a luminance difference between the first area A1 and the second area A2 and a color coordinate offset lookup table 121C including a color coordinate offset related to a color coordinate difference between the first area A1 and the second area A2.

In an embodiment, the luminance offset may represent a luminance deviation rate of the first area A1 to the second area A2. In this case, the luminance offset may be expressed in units of %. The luminance offset lookup table 121L may include luminance offsets LO1[1], LO1[2], . . . , LO1[n−1], LO1[n], . . . , LOm[1], LOm[2], . . . , LOm[n−1], and LOm[n] corresponding to the display luminance values D1, . . . , Dm and the reference grayscales G1[1], G1[2], . . . , G1[n−1], G1[n], . . . , Gm[1], Gm[2], . . . , Gm[n−1], and Gm[n].

In an embodiment, the color coordinate offset may represent a color coordinate deviation amount of the first area A1 to the second area A2. The color coordinate offset may include a u′ offset and a v′ offset. The color coordinate offset lookup table 121C may include u′ offsets UO1[1], UO1[2], . . . , UO1[n−1], UO1[n], . . . , UOm[1], UOm[2], . . . , UOm[n−1], and UOm[n] and v′ offsets VO1[1], VO1[2], . . . , VO1[n−1], VO1[n], . . . , VOm[1], VOm[2], . . . , VOm[n−1], and VOm[n] corresponding to the display brightness values D1, . . . , Dm and the reference grayscales G1[1], G1[2], . . . , G1[n−1], G1[n], . . . , Gm[1], Gm[2], . . . , Gm[n−1], and Gm[n].

The target calculator 120 may calculate the first target optical information (the first target luminance LMT1 and the first target color coordinate CCT1) by increasing or decreasing the second optical information (the second luminance LM2 and the second color coordinate CC2) by the offset. The target calculator 120 may calculate the first target luminance LMT1 by increasing or decreasing the second luminance LM2 of the second area A2 by the luminance offset. In an embodiment, the target calculator 120 may calculate the first target luminance LMT1 by Equation 1, for example.

$$LMT 1 = LM 2 \times ( 1 + LO \times 0.01 ) \qquad [ Equation 1 ]$$

Here, LO is the luminance offset. The target calculator 120 may calculate the first target color coordinate CCT1 by increasing or decreasing the second color coordinate CC2 of the second area A2 by the color coordinate offset.

The gamma determiner 130 may determine the normal reference gamma voltage VRGM0 for the normal area A0 such that a difference between the normal optical information (the normal luminance LM0 and the normal color coordinate CC0) and the normal target optical information (normal target luminance and normal target color coordinate) is within a reference range. The gamma determiner 130 may change the normal reference gamma voltage VRGM0 when the difference between the normal luminance LM0 and the normal target luminance or the difference between the normal color coordinate CC0 and the normal target color coordinate is not within the reference range. The gamma determiner 130 may store the normal reference gamma voltage VRGM0 in a memory of the display device 200 when the difference between the normal luminance LM0 and the normal target luminance or the difference between the normal color coordinate CC0 and the normal target color coordinate is within the reference range. Accordingly, a multi-time programming (“MTP”) for the normal area A0 to repeatedly compensate/correct optical characteristics (or gamma characteristics) for the normal area A0 of the display device 200 may be performed.

The gamma determiner 130 may determine the first reference gamma voltages VRGM1 for the first area A1 such that a difference between the first optical information (the first luminance LM1 and the first color coordinate CC1) and the first target optical information (the first target luminance LMT1 and the first target color coordinate CCT1) is within the reference range. The gamma determiner 130 may change the first reference gamma voltage VRGM1 when the difference between the first luminance LM1 and the first target luminance LMT1 or the difference between the first color coordinate CC1 and the first target color coordinate CCT1 is not within the reference range. The gamma determiner 130 may store the first reference gamma voltage VRGM1 in the memory of the display device 200 when the difference between the first luminance LM1 and the first target luminance LMT1 or the difference between the first color coordinate CC1 and the first target color coordinate CCT1 is within the reference range. Accordingly, an MTP for the first area A1 to repeatedly compensate/correct optical characteristics (or gamma characteristics) for the first area A1 of the display device 200 may be performed.

In the illustrated embodiment, the first target luminance LMT1 or the first target color coordinate CCT1 may be calculated by compensating the second luminance LM2 or the second color coordinate CC2, respectively, based on the offset lookup table 121 including the offset related to the difference between the first area A1 and the second area A2, and the first reference gamma voltages VRGM1 for the first area A1 may be determined such that the difference between the first luminance LM1 and the first target luminance LMT1 or the difference between the first color coordinate CC1 and the first target color coordinate CCT1 is within the reference range, so that the MTP for the first area A1 may be accurately performed. Accordingly, the contrast between the normal area A0 and the first area A1 may decrease, and the display quality of the display device 200 may be improved.

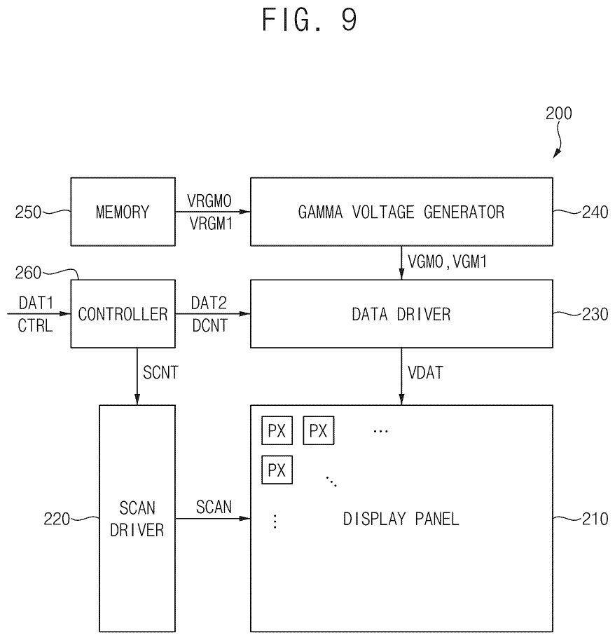

FIG. 9 is a block diagram showing the display device 200 of FIG. 1.

Referring to FIGS. 1 to 9, the display device 200 may include a display panel 210, a scan driver 220, a data driver 230, a gamma voltage generator 240, a memory 250, a controller 260, and an optical module 270.

The display panel 210 may include a plurality of pixels PX. A display area DA may be defined by the pixels PX.

The display panel 210 may include a normal area A0, a first area A1, and a second area A2. The normal area A0 may be an area excluding the first area A1 among the display area DA of the display device 200. The second area A2 may be next to the first area A1. The first area A1 may be an area that displays an image and transmits external light. The normal area A0 including the second area A2 may be an area that displays an image and does not transmit external light.

The scan driver 220 may generate scan signals SCAN based on a scan control signal SCNT, and may provide the scan signals SCAN to the display panel 210. The scan control signal SCNT may include a scan start signal, a scan clock signal, etc.

The data driver 230 may generate data voltages VDAT based on second image data DAT2, a data control signal DCNT, normal gamma voltages VGM0, and first gamma voltages VGM1, and may provide the data voltages VDAT to the display panel 210. The second image data DAT2 may include grayscale values corresponding to the pixels PX. The data control signal DCNT may include a data clock signal, a horizontal start signal, a load signal, etc.

The data driver 230 may convert the second image data DAT2 for the normal area A0 into the data voltages VDAT for the normal area A0 based on the normal gamma voltages VGM0, and may provide the data voltages VDAT for the normal area A0 to the normal area A0 (the pixels PX disposed in the normal area A0).

The data driver 230 may convert the second image data DAT2 for the first area A1 into the data voltages VDAT for the first area A1 based on the first gamma voltages VGM1, and may provide the data voltages VDAT for the first area A1 to the first area A1 (the pixels PX disposed in the first area A1).

The gamma voltage generator 240 may generate the normal gamma voltages VGM0 based on the normal reference gamma voltages VRGM0, and may generate the first gamma voltages VGM1 based on the first reference gamma voltages VRGM1. In an embodiment, the gamma voltage generator 240 may include a resistor string and gamma buffers that transmit the normal reference gamma voltages VRGM0 or the first reference gamma voltages VRGM1 to taps (or tap points) of the resistor string, for example. The gamma voltage generator 240 may generate the normal gamma voltages VGM0 for the entirety of the grayscale by dividing the normal reference gamma voltages VRGM0 applied to the taps using the resistor string, and may generate the first gamma voltages VGM1 for the entirety of the grayscale by dividing the first reference gamma voltages VRGM1 applied to the taps using the resistor string.

The memory 250 may store the normal reference gamma voltages VRGM0 and the first reference gamma voltages VRGM1. The normal reference gamma voltages VRGM0 and the first reference gamma voltages VRGM1 generated by the optical compensation device 100 may be stored in the memory 250 in the form of a lookup table. In an embodiment, the memory 250 may be implemented as a flash memory.

The controller 260 may control an operation of the scan driver 220 and an operation of the data driver 230. The controller 260 may generate the scan control signal SCNT, the second image data DAT2, and the data control signal DCNT based on first image data DAT1 and a control signal CTRL, may provide the scan control signal SCNT to the scan driver 220, and may provide the second image data DAT2 and the data control signal DCNT to the data driver 230. The first image data DAT1 may include grayscale values corresponding to the pixels PX. The control signal CTRL may include a vertical synchronization signal, a horizontal synchronization signal, a global clock signal, a data enable signal, etc.

The optical module 270 may be disposed under the display panel 210, and may overlap the first area A1. In an embodiment, the optical module 270 may overlap only the first area A1, and may not overlap the normal area A0. In an embodiment, the optical module 270 may include at least one of a camera module and a sensor module.

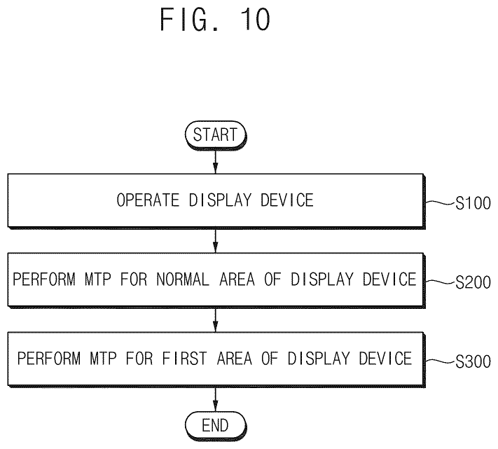

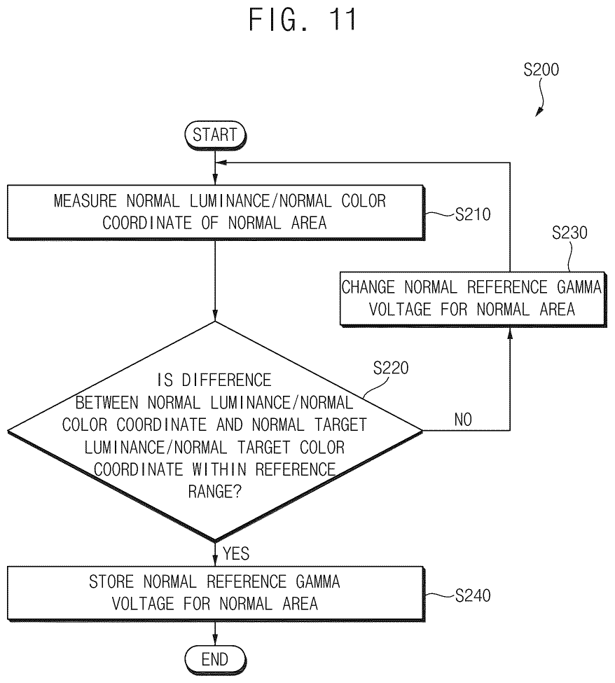

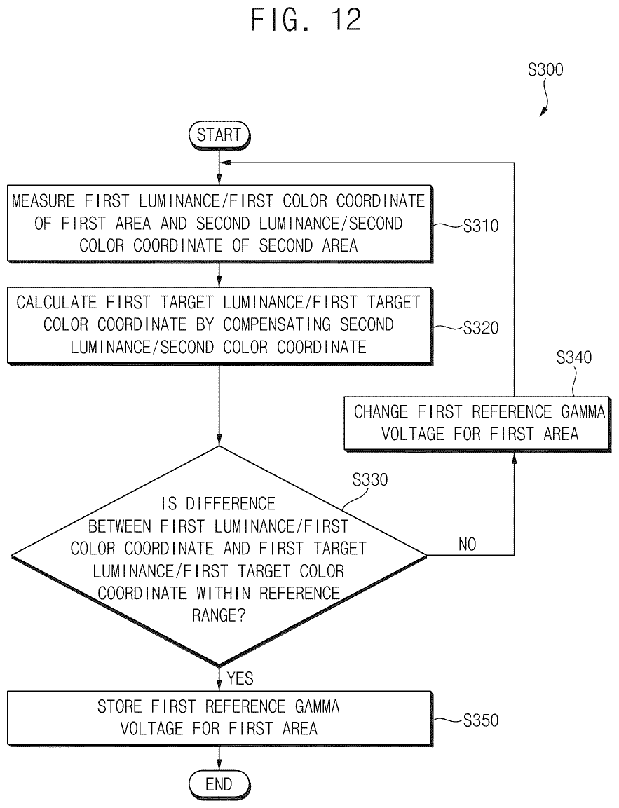

FIG. 10 is a flowchart showing an embodiment of a method of optically compensating a display device 200. FIG. 11 is a flowchart showing performing an MTP for the normal area A0 of FIG. 10. FIG. 12 is a flowchart showing performing an MTP for the first area A1 of FIG. 10.

Referring to FIGS. 1 to 12, in an embodiment of a method of optically compensating a display device 200, the display device 200 may be operated (S100), an MTP for the normal area A0 of the display device 200 may be performed (S200), and an MTP for the first area A1 of the display device 200 may be performed (S300).

In the operating the display device 200 (S100), the data voltages VDAT corresponding to the same grayscale may be provided to the normal area A0 and the first area A1.

In the performing the MTP for the normal area A0 (S200), the normal optical information (the normal luminance LM0 or the normal color coordinate CC0) of the normal area A0 may be measured (S210), and the normal reference gamma voltage VRGM0 for the normal area A0 may be determined such that the difference between the normal optical information (the normal luminance LM0 or the normal color coordinate CC0) and the normal target optical information (the normal target luminance or the normal target color coordinate) is within the reference range.

In the determining the normal reference gamma voltage VRGM0 for the normal area A0, the normal luminance LM0 or the normal color coordinate CC0 and the normal target luminance or the normal target color coordinate may be compared (S220), the normal reference gamma voltage VRGM0 for the normal area A0 may be changed when the difference between the normal luminance LM0 or the normal color coordinate CC0 and the normal target luminance or the normal target color coordinate is not within the reference range (S230), and the normal reference gamma voltage VRGM0 for the normal area A0 may be stored in the memory 250 of the display device 200 when the difference between the normal luminance LM0 and the normal target luminance or the difference between the normal color coordinate CC0 and the normal target color coordinate is within the reference range (S240).

In the performing the MTP for the first area A1 (S300), the first optical information (the first luminance LM1 or the first color coordinate CC1) of the first area A1 and the second optical information (the second luminance LM2 or the second color coordinate CC2) of the second area A2 may be measured (S310), the first target optical information (the first target luminance LMT1 or the first target color coordinate CCT1) may be determined by compensating the second optical information (the second luminance LM2 or the second color coordinate CC2) based on the offset lookup table 121 including the offset related to the difference between the first area A1 and the second area A2 (S320), and the first reference gamma voltage VRGM1 for the first area A1 may be determined such that the difference between the first optical information (the first luminance LM1 or the first color coordinate CC1) and the first target optical information (the first target luminance LMT1 or the first target color coordinate CCT1) is within the reference range.

In the determining the first reference gamma voltage VRGM1 for the first area A1, the first luminance LM1 and the first target luminance LMT1 may be compared or the first color coordinate CC1 and the first target color coordinate CCT1 may be compared (S330), the first reference gamma voltage VRGM1 for the first area A1 may be changed when the difference between the first luminance LM1 and the first target luminance LMT1 or the difference between the first color coordinate CC1 and the first target color coordinate CCT1 is not within the reference range (S340), and the first reference gamma voltage VRGM1 for the first area A1 may be stored in the memory 250 of the display device 200 when the difference between the first luminance LM1 and the first target luminance LMT1 or the difference between the first color coordinate CC1 and the first target color coordinate CCT1 is within the reference range (S350).

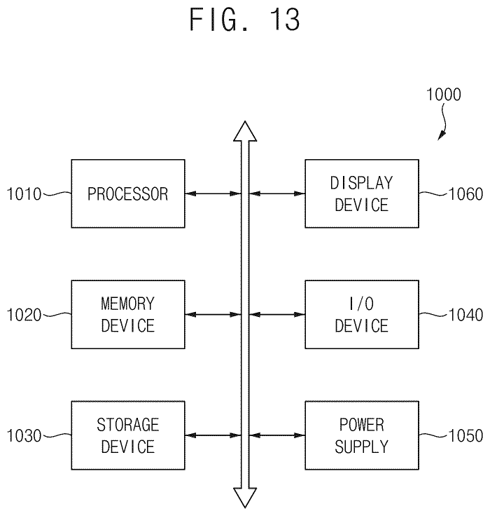

FIG. 13 is a block diagram showing an embodiment of an electronic apparatus 1000.

Referring to FIG. 13, the electronic apparatus 1000 may include a processor 1010, a memory device 1020, a storage device 1030, an input/output (“I/O”) device 1040, a power supply 1050, and a display device 1060. The electronic apparatus 1000 may further include a plurality of ports capable of communicating with a video card, a sound card, a memory card, a USB device, and the like, or communicating with other systems.

The processor 1010 may perform specific calculations or tasks. According to an embodiment, the processor 1010 may be a microprocessor, a central processing unit (“CPU”), or the like. The processor 1010 may be connected to other components through an address bus, a control bus, a data bus, and the like. According to an embodiment, the processor 1010 may also be connected to an expansion bus such as a peripheral component interconnect (“PCI”) bus. In an embodiment, the processor 1010 may provide the first image data DAT1 of FIG. 9 and the control signal CTRL of FIG. 9 to the display device 1060.

The memory device 1020 may store data required for an operation of the electronic apparatus 1000. For example, the memory device 1020 may include: a nonvolatile memory device such as an erasable programmable read-only memory (“EPROM”), an electrically erasable programmable read-only memory (“EEPROM”), a flash memory, a phase change random access memory (“PRAM”), a resistance random access memory (“RRAM”), a nano floating gate memory (“NFGM”), a polymer random access memory (“PoRAM”), a magnetic random access memory (“MRAM”), or a ferroelectric random access memory (“FRAM”); and/or a volatile memory device such as a dynamic random access memory (“DRAM”), a static random access memory (“SRAM”), or a mobile DRAM.

The storage device 1030 may include a solid state drive (“SSD”), a hard disk drive (“HDD”), a CD-ROM, and the like. The I/O device 1040 may include: an input device such as a keyboard, a keypad, a touch pad, a touch screen, or a mouse; and an output device such as a speaker or a printer. The power supply 1050 may supply a power required for the operation of the electronic apparatus 1000. The display device 1060 may be connected to other components through the buses or other communication links. The display device 1060 may correspond to the display device 200 of FIGS. 1 and 9.

The optical compensation device, the display device, and the method of optically compensating the display device in the embodiments may be applied to a display device included in a computer, a notebook, a mobile phone, a smart phone, a smart pad, a smart watch, a portable media player (“PMP”), a personal digital assistance (“PDA”), a motion pictures expert group audio layer III (“MP3”) player, or the like.

Although the optical compensation device, the display device, the method of optically compensating the display device, and the electronic apparatus in the embodiments have been described with reference to the drawings, the shown embodiments are examples, and may be modified and changed by a person having ordinary knowledge in the relevant technical field without departing from the technical spirit described in the following claims.

What is claimed is:

1. An optical compensation device comprising:
a first optical measurer which measures first optical information of a first area of a display device and second optical information of a second area of the display device next to the first area;
a target calculator which calculates first target optical information by compensating the second optical information based on an offset lookup table including an offset related to a difference between the first area and the second area; and
a gamma determiner which determines a first reference gamma voltage for the first area so that a difference between the first optical information and the first target optical information is within a reference range.

2. The optical compensation device of claim 1, wherein the first optical information includes at least one of a luminance and a color coordinate of the first area, and
wherein the second optical information includes at least one of a luminance and a color coordinate of the second area.

3. The optical compensation device of claim 1, wherein the first area displays an image and transmits external light, and
wherein the second area displays the image and does not transmit the external light.

4. The optical compensation device of claim 1, wherein the first optical measurer includes a first probe which measures the first optical information and a second probe which measures the second optical information, and
wherein a length of a first light path from the first probe to the first area is different from a length of a second light path from the second probe to the second area.

5. The optical compensation device of claim 4, wherein the first optical measurer further include a camera module for automatically aligning the first probe to the first area.

6. The optical compensation device of claim 1, wherein the offset is set for each of reference grayscales included in each of display brightness values of the display device.

7. The optical compensation device of claim 1, wherein the offset lookup table includes:
a luminance offset lookup table including a luminance offset related to a luminance difference between the first area and the second area; and
a color coordinate offset lookup table including a color coordinate offset related to a color coordinate difference between the first area and the second area.

8. The optical compensation device of claim 7, wherein the luminance offset represents a luminance deviation rate of the first area to the second area, and
wherein the color coordinate offset represents a color coordinate deviation amount of the first area to the second area.

9. The optical compensation device of claim 1, wherein the target calculator calculates the first target optical information by increasing or decreasing the second optical information by the offset.

10. The optical compensation device of claim 1, further comprising:
a second optical measurer which measures third optical information of a third area of the display device,
wherein the gamma determiner determines a second reference gamma voltage for the third area so that a difference between the third optical information and second target optical information is within the reference range.

11. The optical compensation device of claim 10, wherein the third area and the first area constitute a display area of the display device and do not overlap each other.

12. A display device comprising:
a display panel including a first area and a second area next to the first area;
a gamma voltage generator which generates a first gamma voltage based on a first reference gamma voltage for the first area determined so that a difference between first optical information of the first area and first target optical information is within a reference range; and
a data driver which converts image data for the first area into a data voltage for the first area based on the first gamma voltage and provides the data voltage for the first area to the first area,
wherein the first target optical information is calculated by compensating second optical information of the second area based on an offset lookup table including an offset related to a difference between the first area and the second area.

13. The display device of claim 12, wherein the first optical information includes at least one of a luminance and a color coordinate of the first area, and
wherein the second optical information includes at least one of a luminance and a color coordinate of the second area.

14. The display device of claim 12, wherein the first area displays an image and transmits external light, and
wherein the second area displays the image and does not transmit the external light.

15. The display device of claim 14, further comprising:
an optical module disposed under the display panel and overlapping the first area.

16. A method of optically compensating a display device, the method comprising:
measuring first optical information of a first area of the display device and second optical information of a second area of the display device next to the first area;
calculating first target optical information by compensating the second optical information based on an offset lookup table including an offset related to a difference between the first area and the second area; and
determining a first reference gamma voltage for the first area so that a difference between the first optical information and the first target optical information is within a reference range.

17. The method of claim 16, wherein the first optical information includes at least one of a luminance and a color coordinate of the first area, and
wherein the second optical information includes at least one of a luminance and a color coordinate of the second area.

18. The method of claim 16, wherein the first area displays an image and transmits external light, and
wherein the second area displays the image and does not transmit the external light.

19. The method of claim 16, further comprising:
measuring third optical information of a third area of the display device; and
determining a second reference gamma voltage for the third area so that a difference between the third optical information and second target optical information is within the reference range.

20. The method of claim 19, wherein the third area and the first area constitute a display area of the display device and do not overlap each other.

21. An electronic apparatus comprising a display device which displays an image and a processor which provides image data to the display device, the display device comprising:
a display panel including a first area and a second area next to the first area;
a gamma voltage generator which generates a first gamma voltage based on a first reference gamma voltage for the first area determined so that a difference between first optical information of the first area and first target optical information is within a reference range; and
a data driver which converts the image data for the first area into a data voltage for the first area based on the first gamma voltage and provides the data voltage for the first area to the first area,
wherein the first target optical information is calculated by compensating second optical information of the second area based on an offset lookup table including an offset related to a difference between the first area and the second area.
